(19) United States
(12) Patent Application Publication
(10) Pub. No.: US 2015/0143530 A1
(43) Pub. Date: May 21, 2015

(54) METHOD FOR SHARING FILE AND ELECTRONIC DEVICE THEREOF

(71) Applicant: Samsung Electronics Co., Ltd., Suwon-si (KR)

(72) Inventors: Ki-Huk LEE, Yongin-si (KR); Moon-Soo KIM, Seoul (KR); Jung-Eun LEE, Suwon-si (KR); Ho-Chul HWANG, Seoul (KR)

(21) Appl. No.: 14/497,972

(22) Filed: Sep. 26, 2014

(30) Foreign Application Priority Data
Nov. 20, 2013 (KR) 10-2013-0141411

(51) Int. Cl. G06F 21/16; H04L 29/06

(52) U.S. Cl. CPC G06F 21/16; H04L 65/403
USPC 726/26

(57) ABSTRACT

A method of operating an electronic device is provided. The method includes generating an edition file edited in a form that shares an original file, generating a first sharing file by inserting a watermark into the edition file, transmitting the first sharing file to an external electronic device, receiving a transmission request of a second sharing file corresponding to the original file from the external electronic device, and transmitting the second sharing file to the external electronic device.

### CROSS-REFERENCE TO RELATED APPLICATION(S)

This application claims the benefit under 35 U.S.C. §119(a) of a Korean patent application filed on Nov. 20, 2013 in the Korean Intellectual Property Office and assigned Serial number 10-2013-0141411, the entire disclosure of which is hereby incorporated by reference.

### TECHNICAL FIELD

The present disclosure relates to a method of sharing a file of an electronic device.

### BACKGROUND

As multimedia technology develops, electronic devices having various functions are available. Such electronic devices generally have a convergence function that complexly performs at least one function.

Moreover, a mobile terminal that may be classified into a so-called ‘smart phone’ is generally used as an electronic device. Particularly, such a mobile terminal has a display module of a large screen touch method and has a high pixel camera module in addition to a basic function of communication with another party and thus may photograph a still picture and a moving picture. Further, the mobile terminal may reproduce multimedia content such as music and a moving picture and perform web surfing by connecting to a network.

As such an electronic device gradually includes a high performance processor, the electronic device has been enhanced to more quickly perform various convergence functions and provides a service that freely shares a file with a server and another electronic device through a network.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method of sharing a file and an electronic device thereof that can determine information about an original file and owner information of an original file from a received file in the electronic device.

Another aspect of the present disclosure is to provide a method of sharing a file and an electronic device thereof that can selectively share a portion of an original file in the electronic device.

Another aspect of the present disclosure is to provide a method of sharing a file and an electronic device thereof that can improve a processing speed and that can effectively use a memory, when sharing a file in the electronic device.

Another aspect of the present disclosure is to provide a user interface that can intuitionally request transmission of a specific original file in a situation of sharing a plurality of files in an electronic device.

In accordance with an aspect of the present disclosure, a method of operating an electronic device is provided. The method includes generating an edition file edited in a form that shares an original file, generating a first sharing file by inserting a watermark into the edition file, transmitting the first sharing file to an external electronic device, receiving a transmission request of a second sharing file corresponding to the original file from the external electronic device, and transmitting the second sharing file to the external electronic device.

In accordance with another aspect of the present disclosure, an electronic device is provided. The electronic device includes a watermark generation module, a communication module, a memory, and at least one processor, wherein the at least one processor controls to generate an edition file edited in a form that shares an original file, to generate a first sharing file by inserting a watermark into the edition file, to transmit the first sharing file to an external electronic device, and to transmit a second sharing file to the external electronic device in response to receiving a transmission request of the second sharing file corresponding to the original file from the external electronic device.

In accordance with another aspect of the present disclosure, a method of operating an electronic device is provided. The method includes receiving a first sharing file from an external electronic device, wherein the first sharing file is a file generated by inserting a watermark into an edition file edited in a form that shares an original file in the external electronic device, requesting to transmit a second sharing file corresponding to the original file to the external electronic device, and receiving the second sharing file from the external electronic device.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1A is a perspective view illustrating an electronic device according to an embodiment of the present disclosure;

FIG. 1B is a diagram illustrating a method of sharing a file of an electronic device according to an embodiment of the present disclosure;

FIG. 2A is a block diagram illustrating a configuration of an electronic device according to an embodiment of the present disclosure;

FIG. 2B is a block diagram illustrating a configuration of a processor according to an embodiment of the present disclosure;

FIGS. 3A, 3B, 3C, and 3D are diagrams illustrating a method of sharing a file of an electronic device according to an embodiment of the present disclosure;

FIG. 4 is a flowchart illustrating a method of operating an electronic device according to an embodiment of the present disclosure;

FIG. 5 is a flowchart illustrating a method of operating an electronic device and a second electronic device according to an embodiment of the present disclosure;

FIG. 6 is a flowchart illustrating a method of operating an electronic device and a second electronic device according to an embodiment of the present disclosure;

FIG. 7 is a flowchart illustrating a method of operating an electronic device, a second electronic device, and a server according to an embodiment of the present disclosure;

FIG. 8 is a flowchart illustrating a method of operating an electronic device and a second electronic device according to an embodiment of the present disclosure;

FIG. 9 is a flowchart illustrating a method of operating an electronic device and a second electronic device according to various embodiments of the present disclosure;

FIG. 10 is a flowchart illustrating a method of operating an electronic device and a second electronic device according to various embodiments of the present disclosure; and

FIG. 11 is a flowchart illustrating a method of operating an electronic device according to various embodiments of the present disclosure

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

When describing various embodiments of the present disclosure, an electronic device in which a display device may be applied as a display unit is described, but the electronic device is not limited thereto. For example, the electronic device may be various devices including a display device. According to various embodiments of the present disclosure, an electronic device may include various devices such as a Personal Digital Assistant (PDA), a laptop computer, a mobile phone, a smart phone, a Netbook computer, a television, a Mobile Internet Device (MID), a Ultra Mobile Personal Computer (UMPC), a tablet Personal Computer (PC), a wrist watch, a camera device, a navigation device, a MPEG Layer 3 (MP3) player, a wearable device, and/or the like.

According to various embodiments of the present disclosure, an electronic device may be any combination of the foregoing devices. In addition, it will be apparent to one having ordinary skill in the art that an electronic device according to various embodiments of the present disclosure is not limited to the foregoing devices.

In various embodiments, second electronic device may include external electronic device.

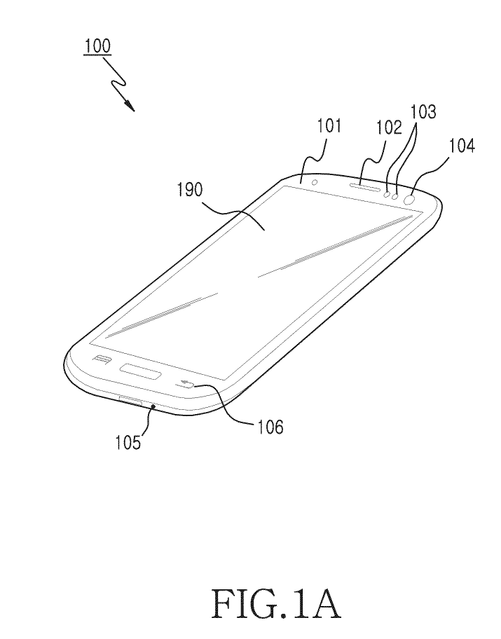

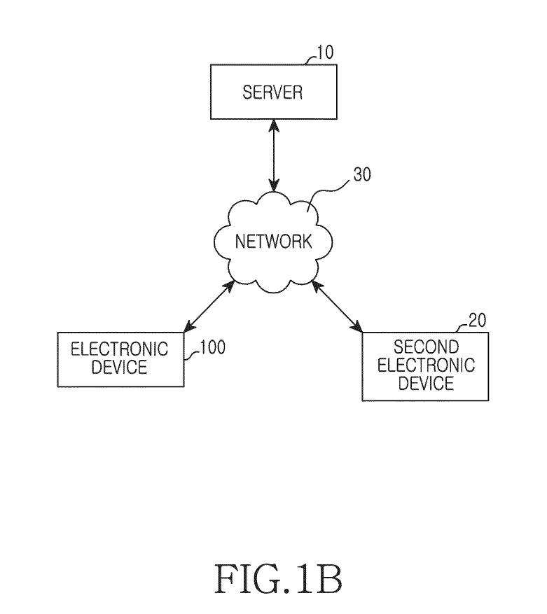

FIG. 1A is a perspective view illustrating an electronic device according to an embodiment of the present disclosure.

Referring to FIG. 1A, an electronic device 100 may include a display device 190 may be installed at a front surface 101 of the electronic device 100. The display device 190 may display an electrical signal received from the electronic device 100 as a text and an image such as graphic and video. Further, the display device 190 may be implemented with a touch screen that can simultaneously input/output data using touch sensor technology.

In an upper portion of the display device 190, an ear piece 102 that transmits and/or receives sound may be installed, and at a periphery of the ear piece 102, a plurality of sensors 103, for use convenience of the electronic device 100, such as a proximity sensor or an illumination sensor, and a camera device 104 for photographing a subject may be disposed.

The electronic device 100 may further include a microphone device 105 located in a lower portion of the display device 190 and that receives an input of sound and a keypad device 106 in which key buttons are disposed. However, elements of the electronic device 100 are not limited thereto and in the electronic device 100, various additional devices for performing known other additional functions may be further installed.

FIG. 1B is a diagram illustrating a method of sharing a file of an electronic device according to an embodiment of the present disclosure.

Referring to FIG. 1B, the electronic device 100 may be connected to a server 10 or a second electronic device (e.g., an external electronic device) 20 through a predetermined network 30. By connecting to the server 10 or the second electronic device 20, the electronic device 100 may transmit and receive a file to and from the server 10 and the second electronic device 20. The server 10 may include a cloud service method of cloud server connected to the electronic device 100 by the network 30 to provide various content.

According to various embodiments of the present disclosure, the electronic device 100 is connected to the server 10 by the network 30 to upload an original file such as a picture or a moving picture to the server 10. Further, the second electronic device 20 is connected to the server 10 by the network 30 to download file information uploaded to the server 10.

According to various embodiments of the present disclosure, the electronic device 100 may share a file with the second electronic device 20 with a Peer to Peer (P2P) method, which is a method of sharing a file by directly connecting with a one-to-one method to the second electronic device 20 instead of using the server 10. For example, the electronic device 100 may transmit and receive a file to and from the second electronic device 20 through a service such as WiFi Direct, e-mail, Short Message Service (SMS), Near Field Communication (NFC), Social Network Service (SNS), and/or the like. However, a method of sharing a file is not limited thereto and various methods in which the electronic device 100 shares a file with the second electronic device 20 may exist.

The second electronic device (e.g., an external electronic device) 20 may correspond to various devices having a communication module. For example, the second device may include or otherwise correspond to various devices such as a PDA, a laptop computer, a mobile phone, a smart phone, a Netbook computer, a television, an MID, a UMPC, a tablet PC, a wrist watch, a camera device, a navigation device, an MP3 player, and/or the like.

The network 30 includes a wired and/or wireless network and may include at least one of a Local Area Network (LAN), a Global System for Mobile Communication (GSM) network, an Enhanced Data GSM Environment (EDGE) network, a Code Division Multiple Access (CDMA) network, a Wideband Code Division Multiple Access (W-CDMA) network, a Long Term Evolution (LTE) network, an Orthogonal Frequency Division Multiple Access (OFDMA) network, a Wireless Fidelity (Wi-Fi) network, a WiMax network, an NFC network, an infrared communication network, and a Bluetooth network, and/or the like according to a communication network.

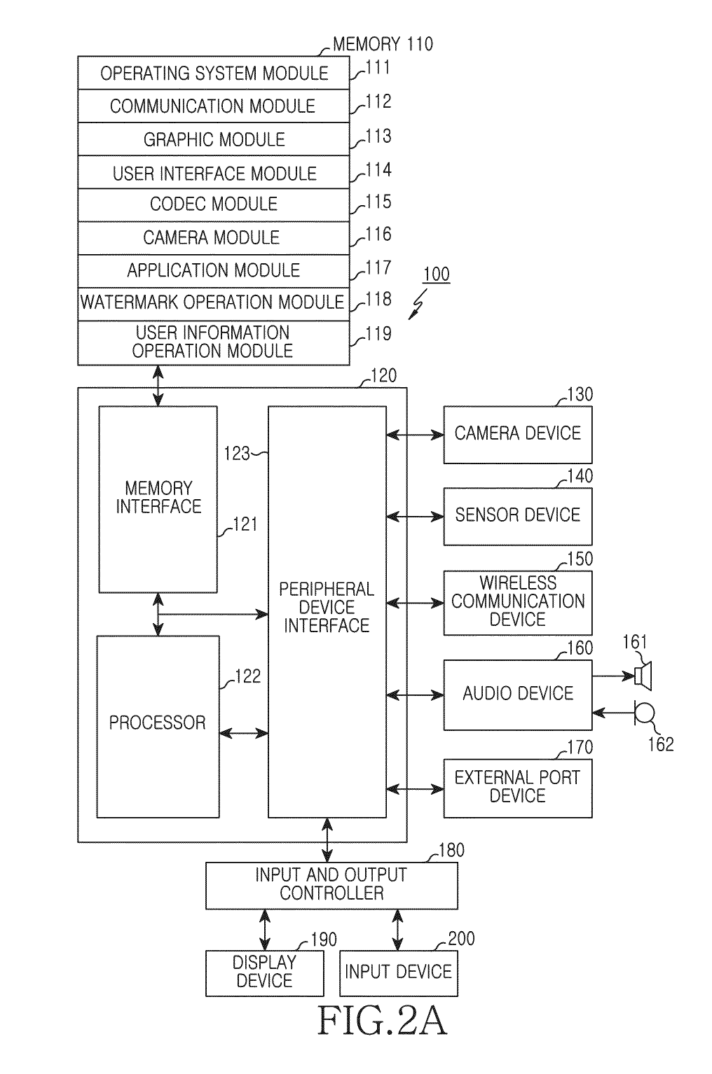

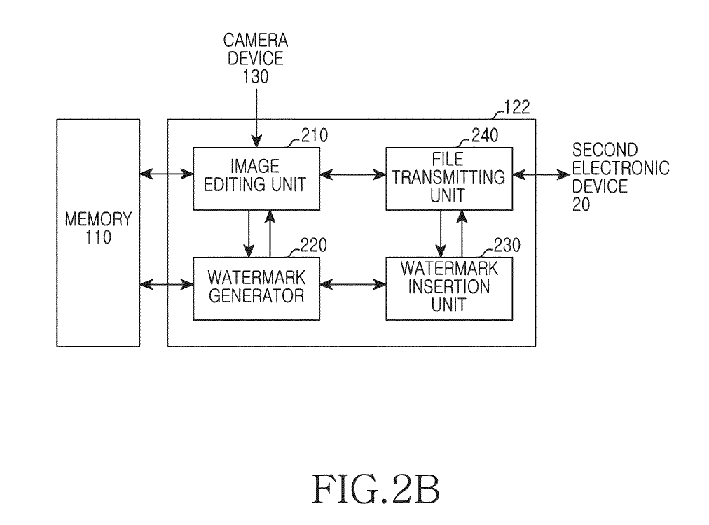

FIG. 2A is a block diagram illustrating a configuration of an electronic device according to an embodiment of the present disclosure.

Referring to FIG. 2A, the electronic device 100 may be a device such as a PDA, a laptop computer, a mobile phone, a smart phone, a Netbook computer, a hand-held computer, an MID, a media player, a UMPC, a tablet PC, a notebook PC, a wrist watch, a navigation device, an MP3 player, a camera device, a wearable device, and/or the like. Further, the electronic device 100 may be a random device including a device in which two or more functions of such devices are coupled.

According to various embodiments of the present disclosure, the electronic device 100 may include a memory 110, a processor unit 120, a camera device 130, a sensor device 140, a wireless communication device 150, an audio device 160, an external port device 170, an input and output controller 180, a display device 190, and an input device 200. The memory 110 and the external port device 170 may be formed in plural.

The processor unit 120 may include a memory interface 121, at least one processor 122, and a peripheral device interface 123. The memory interface 121, the at least one processor 122, and the peripheral device interface 123 included in the processor unit 120 may be integrated into at least one integrated circuit or may be implemented with a separate constituent element.

The memory interface 121 may control access of a constituent element such as the processor 122 or the peripheral device interface 123 to the memory 110.

The peripheral device interface 123 may control a connection to the memory interface 121, the processor 122, and an input and output peripheral device of the electronic device 100.

The processor 122 may control the electronic device 100 to provide various multimedia services using at least one software program. By executing at least one program stored at the memory 110, the processor 122 may provide a service corresponding to the program.

By executing several software programs, the processor 122 may perform several functions for the electronic device 100 and perform a processing and control for audio dedicated communication, audiovisual communication, and data communication. Further, by interlocking with software modules stored at the memory 110, the processor 122 may perform a method according to various embodiments of the present disclosure.

The processor 122 may include at least one data processor, image processor, or coder and decoder (codec). Further, the electronic device 100 may separately form a data processor, an image processor, or a codec.

Various constituent elements of the electronic device 100 may be connected through at least one communication bus (not shown) or an electrical connection means (not shown).

The camera device 130 may perform a camera function of a picture, video clip, and recording. The camera device 130 may include a Charged Coupled Device (CCD), a Complementary Metal-Oxide Semiconductor (CMOS), and/or the like. Further, the camera device 130 may change a hardware configuration, for example, may adjust a lens movement and the number of apertures according to a camera program in which the processor 122 executes.

According to various embodiments of the present disclosure, the camera device 130 may provide images acquired by photographing a subject to the processor unit 120. The camera device 130 may include an image sensor that converts an optical signal to an electrical signal, an image signal processor that converts an analog image signal to a digital image signal, and a digital signal processor that performs an image processing so as to display an image signal output from the image signal processor on the display device 190. Although not shown, the camera device 130 may include an actuator that moves a lens and a driver Integrated Circuit (IC) that drives the actuator.

The sensor device 140 may include a proximity sensor, a hall sensor, an illumination sensor, a motion sensor, and/or the like. For example, the proximity sensor may detect an object approaching the electronic device 100, and the hall sensor may detect a magnetic force of a metal body. Further, the illumination sensor may detect light of a periphery of the electronic device 100, and the motion sensor may include an acceleration sensor or a gyro sensor that detects a motion of the electronic device 100. However, the sensor device 140 is not limited thereto and may further include various sensors for implementing known other additional functions.

The wireless communication device 150 enables to perform wireless communication and may include a radio frequency transmitter and receiver or a light (e.g., infrared rays) transmitter and receiver. Although not shown, the wireless communication device 150 may include a Radio Frequency Integrated Circuit unit (RF IC unit) and a base band processor. The RF IC unit may transmit and receive electromagnetic waves, convert a base band signal from the base band processor to electromagnetic waves, and transmit the electromagnetic waves through an antenna.

The RF IC unit may include an RF transceiver, an amplifier, a tuner, an oscillator, a digital signal processor, a codec chip set, a Subscriber Identity Module (SIM) card, and/or the like.

The wireless communication device 150 may operate through at least one of a GSM network, an EDGE network, a CDMA network, a W-CDMA network, an LTE network, an OFDMA network, a Wi-Fi network, a WiMax network, an NFC network, an Infrared ray communication network, a Bluetooth network according to a communication network, and/or the like. However, the wireless communication device 150 is not limited thereto and may use several communication methods through a protocol for an e-mail, instant messaging, or a SMS.

The audio device 160 may be connected to a speaker 161 and a microphone 162 to perform an audio input and output function such as a speech recognition, voice duplication, digital recording, or communication function. The audio device 160 may provide an audio interface between a user and the electronic device 100, convert a data signal received from the processor 122 to an electric signal, and output the converted electric signal through the speaker 161.

The speaker 161 may convert and output an electric signal to an audible frequency band and be disposed at the front side or the rear side of the electronic device 100. The speaker 161 may include a flexible film speaker in which at least one piezoelectric body is attached to a vibration film.

The microphone 162 may convert a sound wave transferred from a person or other sound sources to an electric signal. The audio device 160 may receive an electric signal from the microphone 162, convert the received electric signal to an audio data signal, and transfer the converted audio data signal to the processor 122. The audio device 160 may include an earphone, an ear set, a headphone, a head set, and/or the like that may be attached or otherwise connected to the electronic device 100 or that may be detached or otherwise disconnected from the electronic device 100.

The external port device 170 may directly connect the electronic device 100 to another electronic device or may be indirectly connected to another electronic device through a network (e.g., Internet, Intranet, wireless local area network (LAN), and/or the like). The external port device 170 may include a Universal Serial Bus (USB) port or a FIREWIRE port.

The input and output controller 180 may provide an interface between the peripheral device interface 123 and an input and output device such as the display device 190 and the input device 200. The input and output controller 180 may include a display device controller and other input device controllers.

The display device 190 may provide an input and output interface between the electronic device 100 and a user. The display device 190 may transfer user touch information to the processor 122 using touch detection technology and show visual information, text, graphic, or video provided from the processor 122 to a user.

The display device 190 may display state information of the electronic device 100, a moving picture, a still picture, a character which the user inputs, and/or the like. Further, the display device 190 may display application related information driven by the processor 122. Such a display device 190 may use at least one of a Liquid Crystal Display (LCD), an Organic Light Emitting Diode (OLED), an Active Mode Organic Light Emitting Diode (AMOLED), a Thin Film Transistor-Liquid Crystal Display (TFT-LCD), a flexible display, a three-dimensional display (3D), and/or the like.

The input device 200 may provide input data generated by a user selection to the processor 122 through the input and output controller 180. The input device 200 may include a keypad including at least one hardware button and a touch pad that detects touch information.

The input device 200 may include a up/down button for a volume control and may further include at least one of pointer devices such as a push button, a locker button, a locker switch, a thumb-wheel, a dial, a stick, a mouse, a track-ball, a stylus, and/or the like in which a corresponding function is given.

The memory 110 may include a non-volatile memory or a high speed Random Access Memory (RAM) such as at least one magnetic disk storage device, at least one light storage device, a flash memory (e.g., NAND, NOR), and/or the like.

The memory 110 stores software, and such software may include an operating system module 111, a communication module 112, a graphic module 113, a user interface module 114, a codec module 115, a camera module 116, an application module 117, a watermark operation module 118, a user information operation module 119, and/or the like. A term of a module may be represented with a set of instructions, an instruction set, or a program.

The operating system module 111 may include a built-in operation system such as WINDOWS, LINUX, Darwin, RTXC, UNIX, OS X, Android or VxWorks and include several software components that control a general system operation. A control of such a general system operation may include memory control and management, storage hardware (device) control and management, and power control and management. Further, the operating system module 111 may perform a function of enabling to smoothly perform communication between several hardware (device) and software components (module).

The communication module 112 may perform communication with another electronic device such as a computer, a server, and an electronic device through the wireless communication device 150 or the external port device 170.

The graphic module 113 may include several software components for providing and displaying graphic to the display device 190. A term of graphic may indicate a text, a web page, an icon, a digital image, a video, an animation, and/or the like.

The user interface module 114 may include several software components related to a user interface. The user interface module 114 may control to display application related information driven by the processor 122 on the display device 190. Further, the user interface module 114 may include content on a change of a user interface state or a condition in which a user interface state is changed.

The codec module 115 may include a software component related to encoding and decoding of a video file.

The camera module 116 may include various software components for performing a camera function (e.g., picture capture, moving picture capture).

The application module 117 may include a software component of at least one application installed in the electronic device 100. Such an application may include a browser, an e-mail, a phonebook, a game, an SMS, a Multimedia Message Service (MMS), an SNS, an instant message, a wake-up call, an MP3 player, a scheduler, a drawing board, a camera, word processing, keyboard emulation, a music player, an address book, a contact list, a widget, Digital Rights Management (DRM), speech recognition, voice duplication, a location determination function, a location based service, a user authentication service, and/or the like. A term of an application may be represented with an application program.

The watermark operation module 118 may include various elements for generating a watermark. The watermark operation module 118 may include an instruction that inserts a generated watermark into a corresponding location of an edition file edited in a sharing form.

The user information operation module 119 may include various user information to be included in a watermark. Such user information may include a name, terminal information, phone number, and ID or profile information of a Social Networking Service (SNS) of a user.

The processor unit 120 may further include an additional module (instructions) in addition to the above-described module.

Various functions of the electronic device 100 may be executed by hardware or software including at least one processing or Application Specific Integrated Circuit (ASIC).

Although not shown, the electronic device 100 may include a power system that supplies power to several constituent elements included therein. The power system may include a power source (AC power source or battery), a power error detection circuit, a power converter, a power inverter, a charge device, or a power state display device (light emitting diode). Further, the electronic device 100 may include a power management and control device that performs a function of generating, managing, and distributing power.

According to various embodiments of the present disclosure, constituent elements of the electronic device 100 are illustrated. However, various embodiments of the present disclosure are not limited thereto. For example, according to various embodiments of the present disclosure, the electronic device 100 may have constituent elements of the number more than or fewer than those shown in the drawings.

FIG. 2B is a block diagram illustrating a configuration of a processor 122 according to an embodiment of the present disclosure.

Referring to FIG. 2B, the processor 122 may include an image editing unit 210, a watermark generator 220, a watermark insertion unit 230, and a file transmitting unit 240. According to various embodiments of the disclosure, the watermark generator 220 and the watermark insertion unit 230 may be formed in a module.

According to various embodiments of the present disclosure, elements of the processor 122 may be formed in separate modules. However, according to various other embodiments of the present disclosure, elements of the processor 122 may include software components within a module.

The image editing unit 210 may edit an original file in a sharing form. For example, the original file may include a text file, an image file, a moving picture file, a sound source file, and/or the like.

According to various embodiments of the present disclosure, in order to transmit an image file received through the camera device 130 to another electronic device, the image editing unit 210 may edit the image file. By executing at least one of resizing, cropping, filtering, or the like of a corresponding image file, the image editing unit 210 may generate an edition file in which a file capacity is reduced.

By executing the watermark operation module 118 stored at the memory 110, the watermark generator 220 may generate a watermark corresponding to an original file.

According to various embodiments of the present disclosure, the watermark generator 220 may generate a watermark including at least one of a file name, Identification (ID), internal metadata, and external metadata of an original file. For example, if the original file is an image file, then internal metadata may include at least one of a photographing time and a photographing location of the image file, sensor sensitivity of an image sensor that photographs the image file, and an exposure time of the image sensor. Further, external metadata may include photographing time information or personal information about a subject. However, internal metadata and external metadata are not limited thereto and may further include various image information.

According to various embodiments of the present disclosure, the watermark generator 220 may generate a watermark including user information having owner information of an original file. For example, user information may include an owner name, terminal information, a phone number, ID or profile information of an SNS of an original file, and/or the like. Further, user information may include an original file transmission request to an owner of an original file from another electronic device. However, user information is not limited thereto and may include various information about an owner of an original file.

By executing the watermark operation module 118 stored at the memory 110, the watermark insertion unit 230 may insert a watermark provided from the watermark generator 220 into an edition file edited for sharing.

According to various embodiments of the present disclosure, the watermark insertion unit 230 may insert a watermark into an edition file such that the watermark is not shown by a naked eye. For example, the watermark insertion unit 230 may insert the watermark into an edition file such that a user may not see the watermark when the file is viewed. For example, the watermark insertion unit 230 may insert a watermark into an edition file to generate a first sharing file. Such a first sharing file may be provided to the file transmitting unit 240.

The file transmitting unit 240 may transmit the first sharing file provided from the watermark insertion unit 230 to the second electronic device 20.

According to various embodiments of the present disclosure, the file transmitting unit 240 may transmit the first sharing file through a connection. For example, the first transmitting unit 240 may transmit the first sharing file through a wireless connection method of one of WiFi, e-mail, SMS, NFC, SNS, and/or the like, and/or a wire connection method through a cable.

According to various embodiments of the present disclosure, the electronic device 100 may receive a second sharing file transmission request corresponding to an original file from the second electronic device 20. The second electronic device 20 may acquire user information of the electronic device 100 through a watermark of the first sharing file received from the electronic device 100. The second electronic device 20 may transmit a second sharing file transmission request to the electronic device 100 through such user information.

In response to receiving the second sharing file transmission request from the second electronic device 20, the electronic device 100 may transmit the second sharing file corresponding to the original file to the second electronic device 20. For example, the second sharing file may be the same as an original file or may be a file more similar to a format of the original file rather than the first sharing file.

According to various embodiments of the present disclosure, constituent elements of the processor 122 are illustrated. However, various embodiments of the present disclosure are not limited thereto. For example, the processor 122 may have constituent elements of the number more than or fewer than that of constituent elements shown in the drawings.

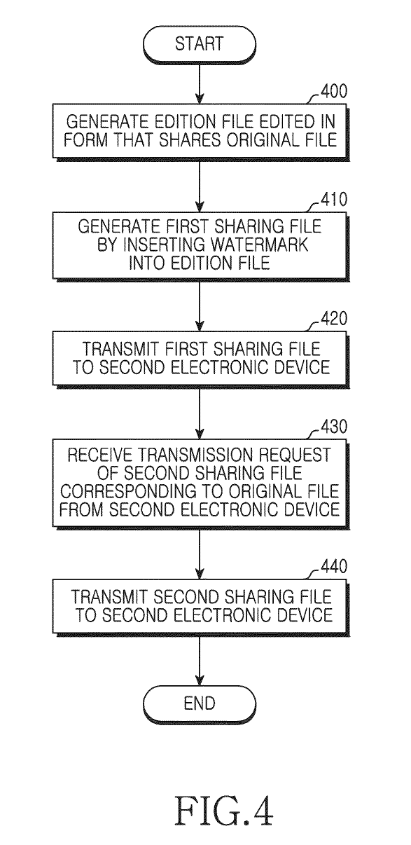

FIG. 4 is a flowchart illustrating a method of operating an electronic device according to an embodiment of the present disclosure.

Referring to FIG. 4, at operation 400, the electronic device 100 may generate an edition file edited in a form that shares an original file.

According to various embodiments of the present disclosure, the image editing unit 210 of the electronic device 100 may edit an original file in a sharing form. For example, the original file may include a text file, an image file, a moving picture file, a sound source file, and/or the like. If the original file is an image file, in order to transmit an image file received through the camera device 130 to another electronic device, the image editing unit 210 may edit the image file. By executing at least one of resizing, cropping, filtering, or the like of a corresponding image file, the image editing unit 210 may generate an edition file in which a file capacity is reduced.

Thereafter, at operation 410, the electronic device 100 may generate a first sharing file by inserting a watermark into the edition file.

According to various embodiment of the present disclosure, the watermark generator 220 of the electronic device 100 may generate a watermark corresponding to the original file. The watermark generator 220 may generate a watermark including at least one of a file name, ID, internal metadata, external metadata, or the like of the original file. For example, if the original file is an image file, internal metadata may include at least one of a photographing time and a photographing location of the image file, sensor sensitivity of an image sensor that photographs the image file, and an exposure time of the image sensor. Further, if the original file is an image file, external metadata may include photographing time information or personal information about a subject. However, internal metadata and external metadata are not limited thereto and may further include various image information.

According to various embodiments of the present disclosure, the watermark generator 220 may generate a watermark including user information having owner information of the original file. For example, user information may include an owner name, terminal information, a phone number, ID or profile information of an SNS of the original file, and/or the like. Further, user information may include an original file transmission request to an owner of the original file from another electronic device. However, user information is not limited thereto and may include various information about an owner of the original file.

According to various embodiments of the present disclosure, the watermark insertion unit 230 of the electronic device 100 may insert a watermark provided from the watermark generator 220 into an edition file edited to share. For example, the watermark insertion unit 230 may insert a watermark into an edition file such that the watermark is not shown by a naked eye. For example, the watermark insertion unit 230 may insert the watermark into an edition file such that a user may not see the watermark when the file is viewed. Further, by inserting a watermark into an edition file, the watermark insertion unit 230 may generate a first sharing file. Such a first sharing file may be provided to the file transmitting unit 240.

Thereafter, at operation 420, the electronic device 100 may transmit the first sharing file to the second electronic device 20.

According to various embodiments of the present disclosure, the file transmitting unit 240 of the electronic device 100 may transmit the first sharing file through a connection. For example, the file transmitting unit 240 of the electronic device may transmit the first sharing file through a wireless connection method of at least one of WiFi, e-mail, SMS, NFC, SNS, a wire connection method through a cable, and/or the like.

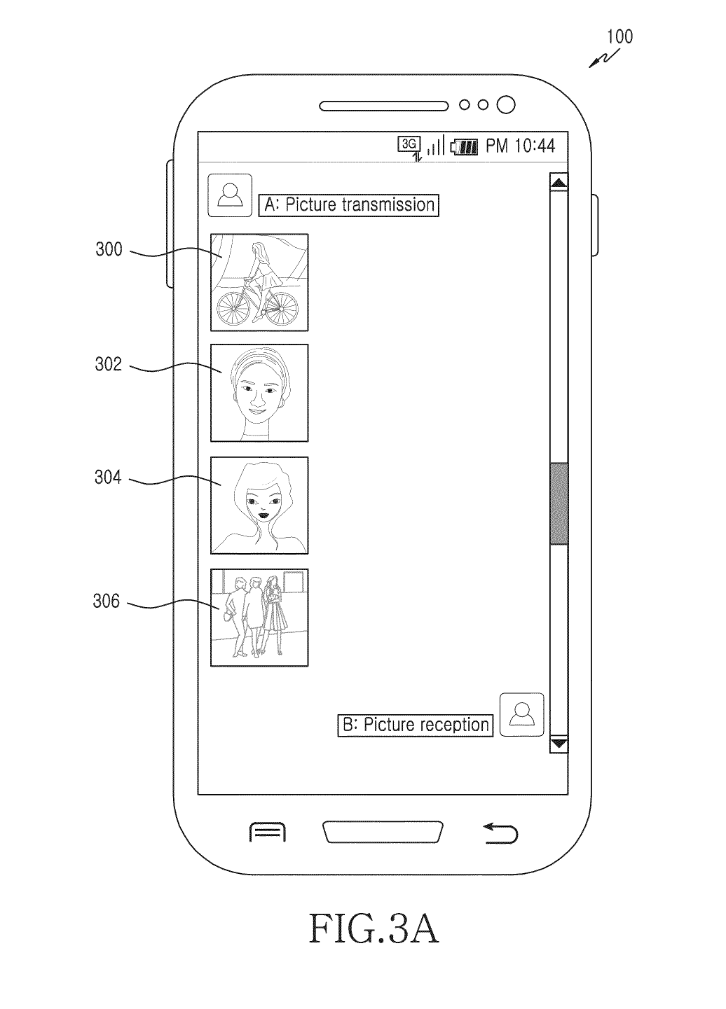

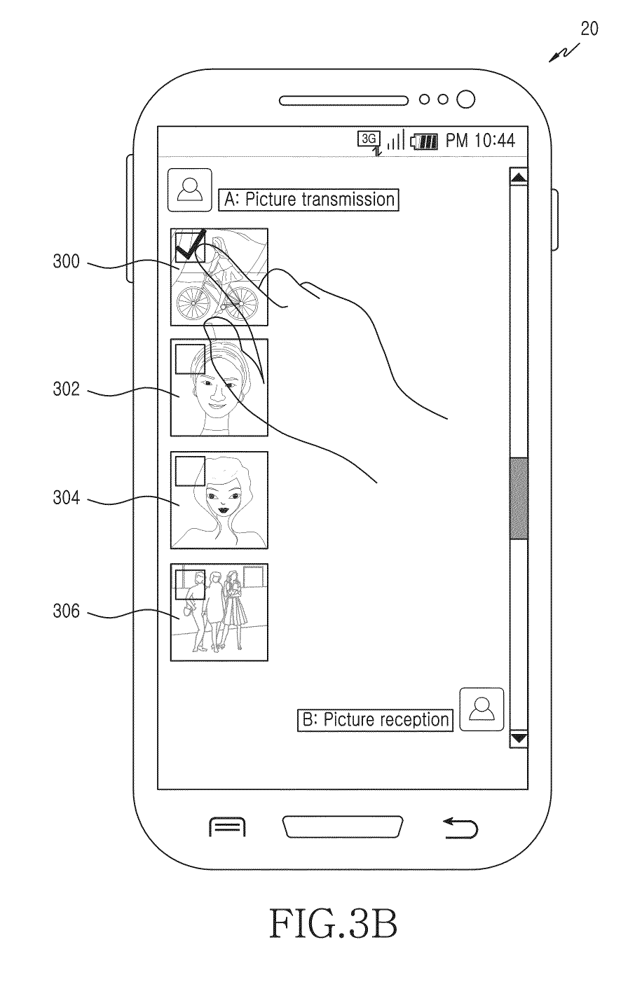

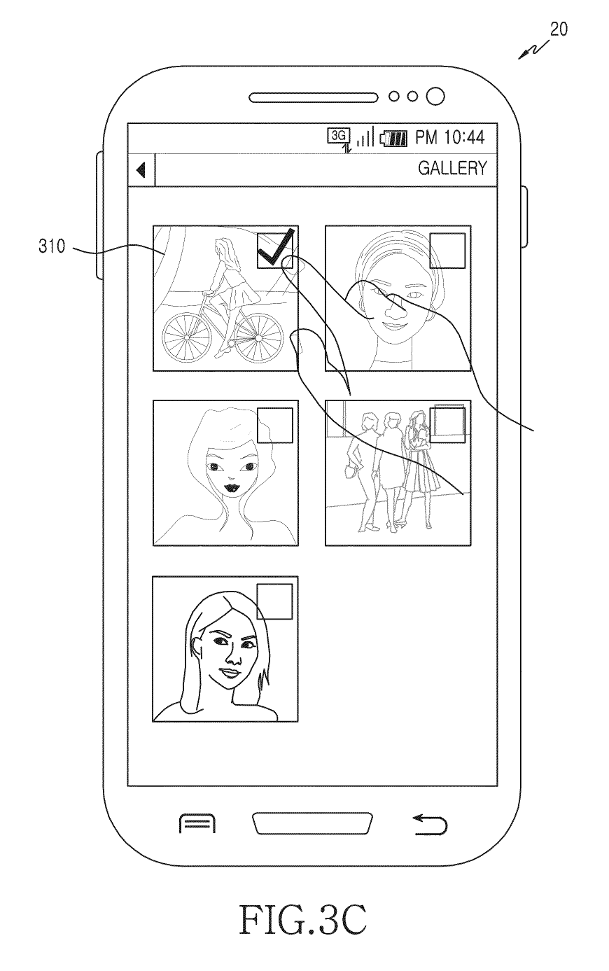

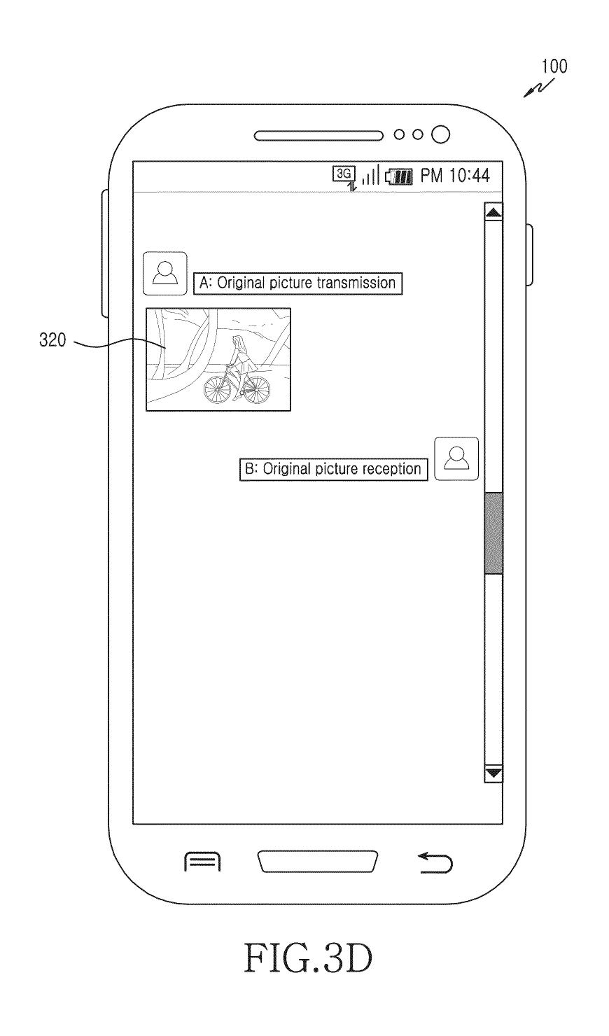

FIGS. 3A, 3B, 3C, and 3D are diagrams illustrating a method of sharing a file of an electronic device according to an embodiment of the present disclosure.

Referring to FIG. 3A, the electronic device 100 may transmit each of first sharing files 300, 302, 304, and 306 corresponding to an original file to another electronic device through an SNS. For example, if the original file is an image file, then the first sharing files 300, 302, 304, and 306 may be displayed with a thumbnail image. As an example, the first sharing files 300, 302, 304, and 306 may be displayed with an icon.

Thereafter, at operation 430, the electronic device 100 may receive a transmission request of a second sharing file corresponding to the original file from the second electronic device 20.

According to various embodiments of the present disclosure, the second electronic device 20 may acquire user information of the electronic device 100 through a watermark of the first sharing file received from the electronic device 100. The second electronic device 20 may transmit a second sharing file transmission request to the electronic device 100 through such user information. For example, the second sharing file may be the same as the original file or may be a file more similar to a format of the original file rather than the first sharing file.

Referring to FIGS. 3B and 3C, the second electronic device 20 may select at least one of the first sharing files 300, 302, 304, and 306 received from the electronic device 100 and transmit a transmission request of a second sharing file corresponding to a corresponding original file to the electronic device 100.

According to various embodiments of the present disclosure, the second electronic device 20 may select the first sharing file 300 displayed with a thumbnail image or may select a first sharing file 310 stored at the second electronic device 20 and transmit a second sharing file transmission request to the electronic device 100. However, various embodiments of the present disclosure are not limited thereto and various selection methods may be used.

Thereafter, at operation 440, the electronic device 100 may transmit a second sharing file to the second electronic device 20.

According to various embodiments of the present disclosure, the electronic device 100 may generate a second sharing file more similar to the original file rather than the first sharing file. For example, if the original file is an image file, the electronic device 100 may transmit an entire original image file to the second electronic device 20 or may transmit an image file most similar to the original image file. The second sharing file may be a file more similar to a format of the original file rather than the first sharing file.

Referring to FIG. 3D, the electronic device 100 may transmit a second sharing file 320 corresponding to the selected first sharing file 300 to another electronic device. A wireless connection method of at least one of WiFi, e-mail, SMS, NFC, SNS, and/or the like, and/or a wire connection method through a cable may be applied to such transmission. However, according to various embodiments of the present disclosure are not limited thereto.

An instruction set of such each operation may be stored in at least one module at the memory 110. In this case, a module stored at the memory 110 may be executed by at least one processor 122.

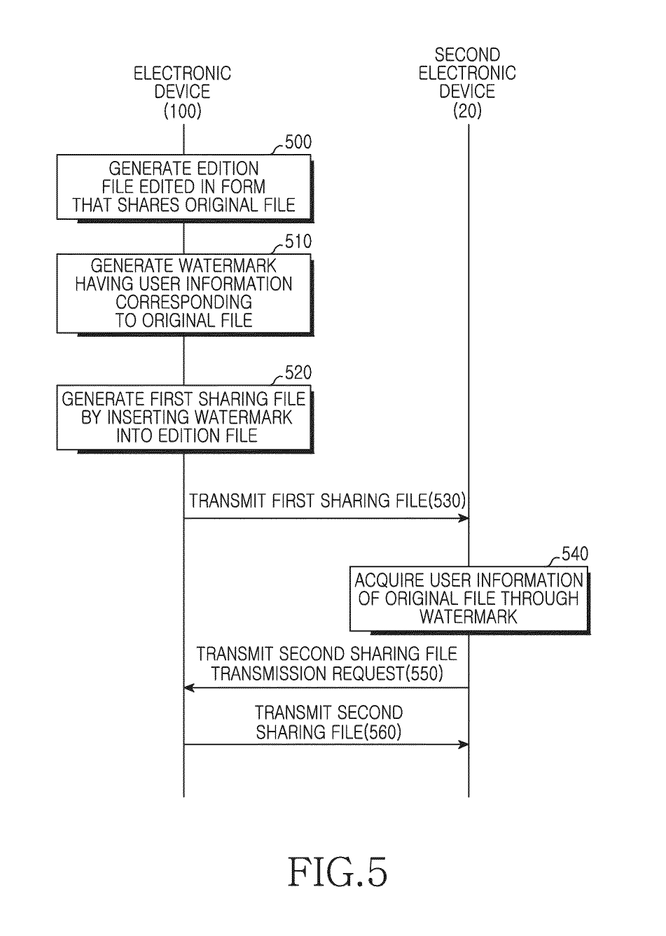

FIG. 5 is a flowchart illustrating a method of operating an electronic device and a second electronic device according to an embodiment of the present disclosure.

Referring to FIG. 5, at operation 500, the electronic device 100 may generate an edition file edited in a form that shares an original file.

According to various embodiments of the present disclosure, the image editing unit 210 of the electronic device 100 may edit an original file in a sharing form. For example, the original file may include a text file, an image file, a moving picture file, a sound source file, and/or the like. If the original file is an image file, then the image editing unit 210 may edit the image file received through the camera device 130 so as to transmit to the second electronic device 20. By executing at least one of resizing, cropping, filtering, and the like of a corresponding image file, the image editing unit 210 may generate an edition file in which a file capacity is reduced.

According to various embodiments of the present disclosure, a case in which the original file is an image file is illustrated. However, according to various embodiments of the present disclosure, the original file is not limited thereto. For example, even if the original file is a text file, a moving picture file, a sound source file, and/or the like, the foregoing editing work may be performed.

Thereafter, at operation 510, the electronic device 100 may generate a watermark having user information corresponding to the original file.

According to various embodiments of the present disclosure, the watermark generator 220 of the electronic device 100 may generate a watermark including user information having owner information of the original file. For example, user information may include an owner name, terminal information, a phone number, an ID or profile information of an SNS of the original file, and/or the like. Further, user information may include may include an original file transmission request to an owner of the original file from another electronic device. However, user information is not limited thereto and may include various information about an owner of the original file.

According to various embodiments of the present disclosure, the watermark generator 220 of the electronic device 100 may generate a watermark including at least one of a file name, ID, internal metadata, and external metadata of the original file. For example, if the original file is an image file, internal metadata may include at least one of a photographing time and a photographing location of the image file, sensor sensitivity of an image sensor that photographs the image file, an exposure time of the image sensor, and/or the like. Further, if the original file is an image file, then external metadata may include photographing time information or personal information of a subject. However, internal metadata and external metadata are not limited thereto and may further include various image information.

Thereafter, at operation 520, the electronic device 100 may generate a first sharing file by inserting a watermark into an edition file.

According to various embodiments of the present disclosure, the watermark insertion unit 230 of the electronic device 100 may insert a watermark provided from the watermark generator 220 into an edition file edited to share. For example, the watermark insertion unit 230 may insert a watermark into an edition image such that the watermark is not shown by a naked eye. Such a first sharing file may be provided to the file transmitting unit 240.

Thereafter, at operation 530, the electronic device 100 may transmit the first sharing file to the second electronic device 20.

According to various embodiments of the present disclosure, the file transmitting unit 240 of the electronic device 100 may transmit the first sharing file to the second electronic device 20 through a connection. For example, the file transmitting unit 240 of the electronic device 100 may transmit the first sharing file to the second electronic device 20 through a wireless connection method of at least one of WiFi, e-mail, SMS, NFC, SNS, and the like, and/or a wire connection method through a cable.

Thereafter, at operation 540, the second electronic device 20 may acquire user information of the original file through the watermark.

According to various embodiments of the present disclosure, the second electronic device 20 may extract a watermark of the first sharing file according to a predetermined rule and acquire user information included in the extracted watermark.

Thereafter, at operation 550, the second electronic device 20 may transmit a second sharing file transmission request to the electronic device 100.

According to various embodiments of the present disclosure, the second electronic device 20 may input an original file transmission request instruction to the electronic device 100 through the acquired user information.

Thereafter, at operation 560, the electronic device 100 may transmit the second sharing file to the second electronic device 20.

According to various embodiments of the present disclosure, in response to receiving the second sharing file transmission request, the electronic device 100 may transmit the second sharing file to the second electronic device 20 or may transmit the second sharing file in which a watermark is inserted to the second electronic device 20 according to whether the electronic device 100 allows. For example, if the original file is an image file, then the electronic device 100 may transmit an entire original image file to the second electronic device 20 or may transmit an image file most similar to the original image file. The second sharing file may be a file more similar to a format of the original file rather than the first sharing file. A wireless connection method of at least one of WiFi, e-mail, SMS, NFC, SNS, and the like, and/or a wire connection method through a cable may be applied to such transmission. However, according to various embodiments of the present disclosure, such a transmission method is not limited thereto.

According to various embodiments of the present disclosure, two sharing files are illustrated. However, according to various embodiments of the present disclosure, the number of sharing files is not limited thereto. For example, at least three sharing files corresponding to the original file may exist, and in such a case, each sharing file may be sequentially transmitted to the second electronic device 20.

An instruction set of such each operation may be stored in at least one module at the memory 110. In this case, a module stored at the memory 110 may be executed by at least one processor 122.

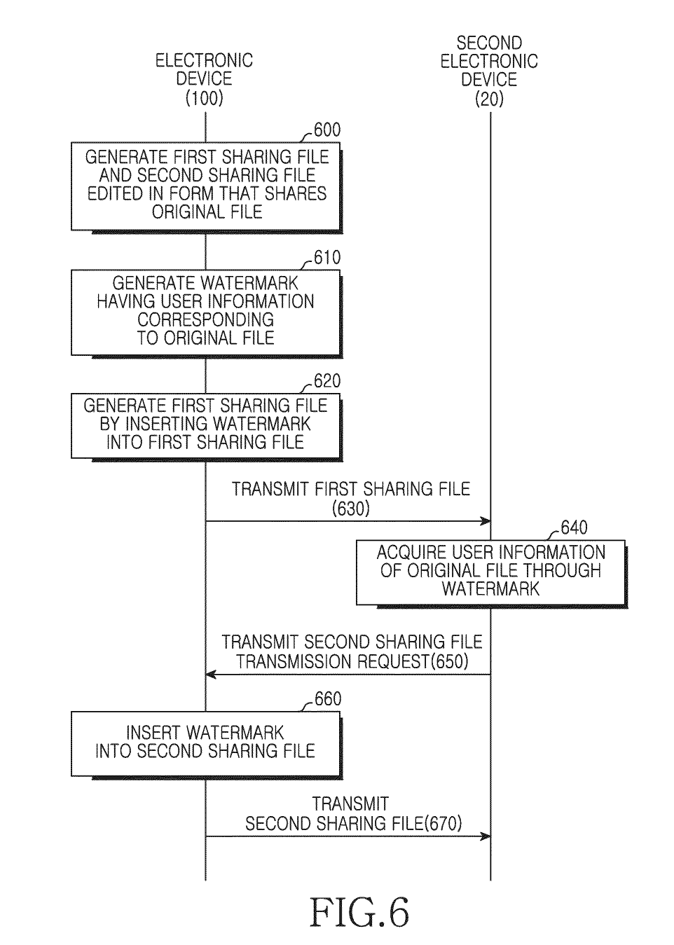

FIG. 6 is a flowchart illustrating a method of operating an electronic device and a second electronic device according to an embodiment of the present disclosure.

Referring to FIG. 6, at operation 600, the electronic device 100 may generate a first sharing file and a second sharing file edited in a form that shares an original file.

According to various embodiments of the present disclosure, the image editing unit 210 of the electronic device 100 may edit the original file in a sharing form. For example, the original file may include a text file, an image file, a moving picture file, a sound source file, and/or the like. If the original file is an image file, then in order to transmit an image file received through the camera device 130 to the second electronic device 20, the image editing unit 210 may edit the image file. By executing at least one of resizing, cropping, filtering, and/or the like of a corresponding image file, the image editing unit 210 may generate a first sharing file and a second sharing file in which a file capacity is reduced. For example, the second sharing file may be a file more similar to a format of the original file rather than the first sharing file and may be the original file.

According to various embodiments of the present disclosure, a case in which the original file is an image file is illustrated. However, according to various embodiments of the present disclosure, the original file is not limited thereto. For example, even if the original file is a text file, a moving picture file, a sound source file, and/or the like, the foregoing editing work may be performed.

Thereafter, at operation 610, the electronic device 100 may generate a watermark having user information corresponding to the original file.

According to various embodiments of the present disclosure, the watermark generator 220 of the electronic device 100 may generate a watermark including user information having owner information of the original file. For example, user information may include an owner name, terminal information, a phone number, an ID or profile information of an SNS of the original file, and/or the like. Further, user information may include an original file transmission request to an owner of the original file from another electronic device. However, user information is not limited thereto and may include various information about an owner of the original file.

According to various embodiments of the present disclosure, the watermark generator 220 of the electronic device 100 may generate a watermark including at least one of a file name, ID, internal metadata, external metadata of the original file, and/or the like. For example, if the original file is an image file, then internal metadata may include at least one of a photographing time and a photographing location of the image file, sensor sensitivity of an image sensor that photographs the image file, and an exposure time of the image sensor. Further, if the original file is an image file, then external metadata may include photographing time information or personal information of a subject. However, internal metadata and external metadata are not limited thereto and may further include various image information.

Thereafter, at operation 620, the electronic device 100 may generate a first sharing file by inserting a watermark into the first sharing file.

According to various embodiments of the present disclosure, the watermark insertion unit 230 of the electronic device 100 may insert a watermark provided from the watermark generator 220 into the first sharing file. For example, the watermark insertion unit 230 may insert a watermark into the first sharing file such that the watermark is not shown by a naked eye. Such a first sharing file may be provided to the file transmitting unit 240.

Thereafter, at operation 630, the electronic device 100 may transmit the first sharing file to the second electronic device 20.

According to various embodiments of the present disclosure, the file transmitting unit 240 of the electronic device 100 may transmit the first sharing file to the second electronic device 20 through a connection. For example, the file transmitting unit 240 of the electronic device 100 may transmit the first sharing file to the second electronic device 20 through a wireless connection method of at least one of WiFi, e-mail, SMS, NFC, SNS, and the like, and/or a wire connection method through a cable.

Thereafter, at operation 640, the second electronic device 20 may acquire user information of the original file through the watermark.

According to various embodiments of the present disclosure, the second electronic device 20 may extract a watermark of the first sharing file according to a predetermined rule and acquire user information included in the extracted watermark.

Thereafter, at operation 650, the second electronic device 20 may transmit a second sharing file transmission request to the electronic device 100.

According to various embodiments of the present disclosure, the second electronic device 20 may input an original file transmission request instruction to the electronic device 100 through the acquired user information.

Thereafter, at operation 660, the electronic device 100 may insert a watermark into the second sharing file.

According to various embodiments of the present disclosure, in response to receiving the second sharing file transmission request, the electronic device 100 may generate a watermark corresponding to the second sharing file. Such a watermark may be the same as or at least partially equal to a watermark inserted into the first sharing file.

Thereafter, at operation 670, the electronic device 100 may transmit the second sharing file to the second electronic device 20.

According to various embodiments of the present disclosure, the electronic device 100 may transmit the second sharing file to the second electronic device 20 according to whether the electronic device 100 allows. A wireless connection method of at least one of WiFi, e-mail, SMS, NFC, SNS, and the like, and/or a wire connection method through a cable may be applied to such transmission. However, such a transmission method is not limited thereto.

According to various embodiments of the present disclosure, two sharing files are exemplified. However, according to various embodiments of the present disclosure, the number of sharing files is not limited thereto. For example, at least three sharing file corresponding to the original file may exist, and in such a case, each sharing file may be sequentially transmitted to the second electronic device 20.

An instruction set of such each operation may be stored in at least one module at the memory 110. In this case, a module stored at the memory 110 may be executed by at least one processor 122.

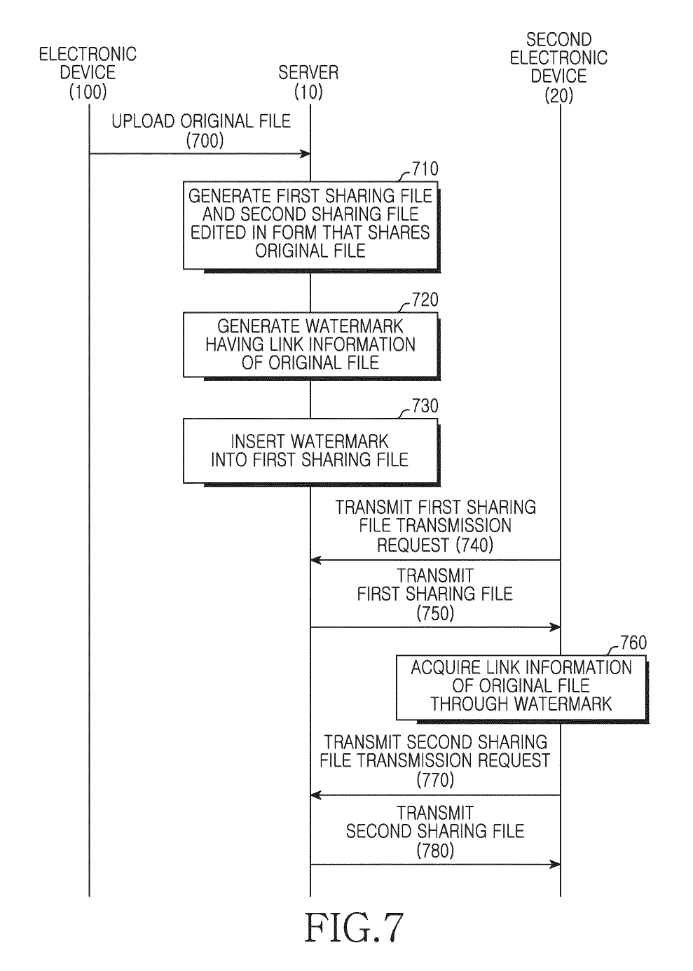

FIG. 7 is a flowchart illustrating a method of operating an electronic device, a second electronic device, and a server according to an embodiment of the present disclosure.

Referring to FIG. 7, at operation 700, the electronic device 100 may upload an original file to the server 10.

According to various embodiments of the present disclosure, the electronic device 100 may transmit an original file including at least one of a text file, an image file, a moving picture file, a sound source file, and/or the like to the server 10. The server 10 may include a cloud service method of cloud server connected to the electronic device 100 or the second electronic device 20 by a network to provide various content.

Thereafter, at operation 710, the server 10 may generate a first sharing file and a second sharing file edited in a form that shares the original file.

According to various embodiments of the present disclosure, if the original file is an image file, then the server 10 may analyze an image file received from the electronic device 100, execute at least one of resizing, cropping, filtering, and/or the like of a corresponding image file, and generate a first sharing file and a second sharing file in which a file capacity is reduced. For example, the second sharing file may be a file more similar to a format of the original file rather than the first sharing file and may be the original file.

According to various embodiments of the present disclosure, a case in which the original file is an image file is illustrated. However, according to various embodiments of the present disclosure, the original file is not limited thereto. For example, even if the original file is a text file, a moving picture file, a sound source file, and/or the like, the foregoing edition work may be performed.

Thereafter, at operation 720, the server 10 may generate a watermark having link information of the original file.

According to various embodiments of the present disclosure, the server 10 may generate metadata including location information in which the original file is stored or a watermark having link information including a link address in which the original file may be executed. However, a watermark is not limited thereto and may further include various information of the original file.

Thereafter, at operation 730, the server 10 may insert a watermark into the first sharing file.

According to various embodiments of the present disclosure, if the first sharing file is an image file, the server 10 may insert an invisible watermark into the first sharing file such that the watermark is not shown by a naked eye. For example, the server 10 may insert the watermark into an edition file such that a user may not see the watermark when the file is viewed. For example, the server 10 may insert desired information into an area having a specific frequency after a Discrete Cosine Transform (DCT) operation of an image file and insert desired information into a specific frequency image after wavelet conversion.

According to various embodiments of the present disclosure, the server 10 may generate a first sharing file into which the foregoing watermark is inserted in an album form and distribute the first sharing file to another electronic device. In order to determine whether an image inserted into the album is modulated, the server 10 may generate and distribute a watermark of the album from information related to the inserted image.

Thereafter, at operation 740, the second electronic device 20 may transmit a first sharing file transmission request to the server 10.

At operation 750, in response to the server 10 receiving the first sharing file transmission request, the server 10 may transmit the first sharing file to the second electronic device 20.

According to various embodiments of the present disclosure, the server 10 may transmit the first sharing file to the second electronic device 20 through a connection. For example, the server 10 may transmit the first sharing file to the second electronic device 20 through a wireless connection method of one at least of WiFi, e-mail, SMS, SNS, and the like, and/or a wired connection.

Thereafter, at operation 760, the second electronic device 20 may acquire link information of the original file through the watermark.

According to various embodiments of the present disclosure, the second electronic device 20 may extract a watermark of the first sharing file according to a predetermined rule and acquire link information included in the extracted watermark.

Thereafter, at operation 770, the second electronic device 20 may transmit a second sharing file transmission request to the server 10.

According to various embodiments of the present disclosure, the second electronic device 20 may request to transmit the original file from an extracted link address to the server 10.

Thereafter, at operation 780, the server 10 may transmit the second sharing file to the second electronic device 20.

According to various embodiments of the present disclosure, in response to the server 10 receiving the second sharing file transmission request, the server 10 may transmit the second sharing file to the second electronic device 20 or may transmit the second sharing file into which a watermark is inserted to the second electronic device 20 according to whether the server 10 allows. If the second sharing file is an image file, then the second sharing image may be an image inserted to show a predetermined watermark into the original image and may be the same image as the original image according to setting of the electronic device 100.

According to various embodiments of the present disclosure, two sharing files are exemplified. However, according to various embodiments of the present disclosure, the number of sharing files is not limited thereto. For example, three sharing files corresponding to the original file may exist, and in such a case, each sharing file may be sequentially transmitted to the second electronic device 20.

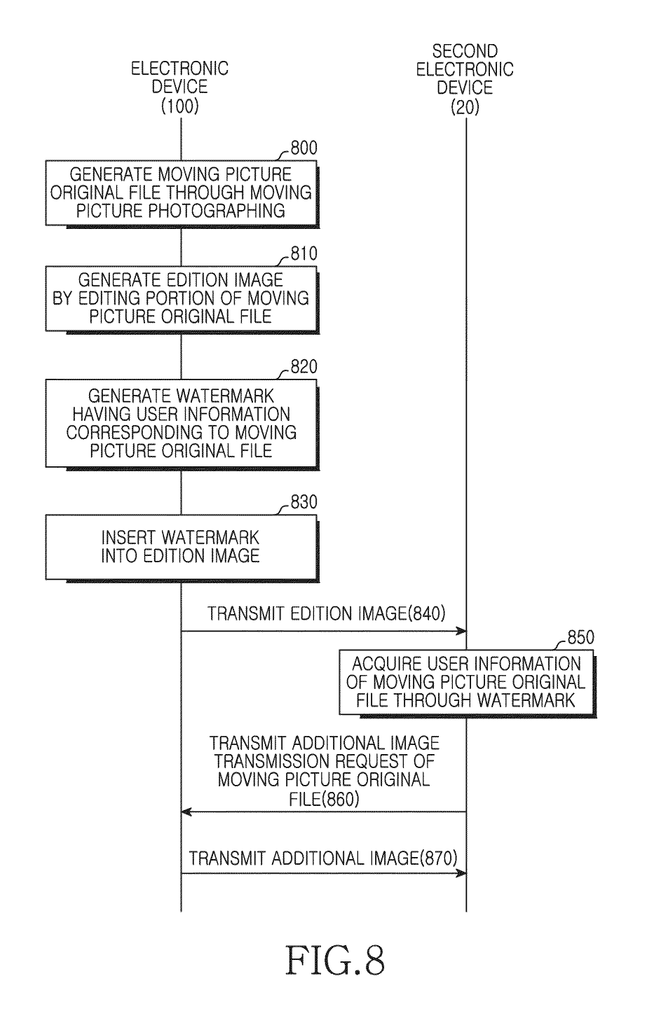

FIG. 8 is a flowchart illustrating a method of operating an electronic device and a second electronic device according to an embodiment of the present disclosure.

Referring to FIG. 8, at operation 800, the electronic device 100 may generate a moving picture original file through moving picture capture.

According to various embodiments of the present disclosure, the electronic device 100 may generate a moving picture received through an image sensor into a moving picture file.

Thereafter, at operation 810, the electronic device 100 may generate an edition image by editing a portion of the moving picture original file.

According to various embodiments of the present disclosure, the image editing unit 210 of the electronic device 100 may edit the moving picture original file in a sharing form. The image editing unit 210 may reduce a file capacity by executing at least one of resizing, cropping, filtering, and/or the like of a corresponding moving picture file and generate a new moving picture file by combining a portion of the moving picture.

Thereafter, at operation 820, the electronic device 100 may generate a watermark having user information corresponding to the moving picture original file.

According to various embodiments of the present disclosure, the watermark generator 220 of the electronic device 100 may generate a watermark including user information having owner information of the moving picture original file. For example, user information may include an owner name, terminal information, a phone number, an ID or profile information of an SNS of the original file, and/or the like. Further, user information may include an original file transmission request to an owner of the original file from another electronic device. However, user information is not limited thereto and may include various information about an owner of the original file.

According to various embodiments of the present disclosure, the watermark generator 220 of the electronic device 100 may generate a watermark including at least one of a file name, ID, internal metadata, or external metadata of the original file. For example, internal metadata may include at least one of a photographing time and a photographing location of the moving picture file, sensor sensitivity of an image sensor that photographs the moving picture file, and an exposure time of the image sensor. Further, external metadata may include photographing time information or personal information of a subject. However, internal metadata and external metadata are not limited thereto and may further include various moving picture information.

Thereafter, at operation 830, the electronic device 100 may insert a watermark into the edition image.

According to various embodiments of the present disclosure, the watermark insertion unit 230 of the electronic device 100 may insert a watermark provided from the watermark generator 220 into the edition image. For example, the watermark insertion unit 230 may insert a watermark into the edition image such that the watermark is not shown by a naked eye, recognize a character on a moving picture scene basis, and perform watermarking of character information together with original image owner information to the image.

Thereafter, at operation 840, the electronic device 100 may transmit the edition image to the second electronic device 20.

According to an embodiment, the file transmitting unit 240 of the electronic device 100 may transmit the edition image to the second electronic device 20 through a wireless connection method of at least one of WiFi, e-mail, SMS, NFC, SNS, and the like, and/or a wire connection method through a cable.

Thereafter, at operation 850, the second electronic device 20 may acquire user information of the moving picture original file through the watermark.

According to various embodiments of the present disclosure, the second electronic device 20 may extract a watermark of the edition image according to a predetermined rule and acquire user information included in the extracted watermark.

Thereafter, at operation 860, the second electronic device 20 may transmit an additional image transmission request of the moving picture original file to the electronic device 100.

According to various embodiments of the present disclosure, the second electronic device 20 may input an additional image transmission request instruction to the electronic device 100 through the acquired user information. The additional image may be an image captured by the second electronic device 20, but is not limited thereto. For example, the second electronic device 20 may identify an original file owner with the watermark and transmit a captured image to the original file owner.

Thereafter, at operation 870, the electronic device 100 may transmit an additional image to the second electronic device 20.

According to various embodiments of the present disclosure, in response to receiving an additional image request, the electronic device 100 may transmit an additional image file to the second electronic device 20 or may transmit an additional image file into which a watermark is inserted to the second electronic device 20 according to whether the electronic device 100 allows. For example, the electronic device 100 may encode only a corresponding portion of an entire image from the received captured image and transmit the encoded image to the second electronic device 20. The additional image file may be a file more similar to a format of the original file rather than the edition file. A wireless connection method of at least one of WiFi, e-mail, SMS, NFC, SNS, and the like, and/or a wire connection method through a cable may be applied to such transmission. However, according to various embodiments of the present disclosure, such a transmission method is not limited thereto.

According to the various embodiments of the present disclosure, sharing an entire image is difficult, the electronic device 100 may limitedly share a specific portion of the image using watermarking.

An instruction set of such each operation may be stored in at least one module at the memory 110. In this case, a module stored at the memory 110 may be executed by at least one processor 122.

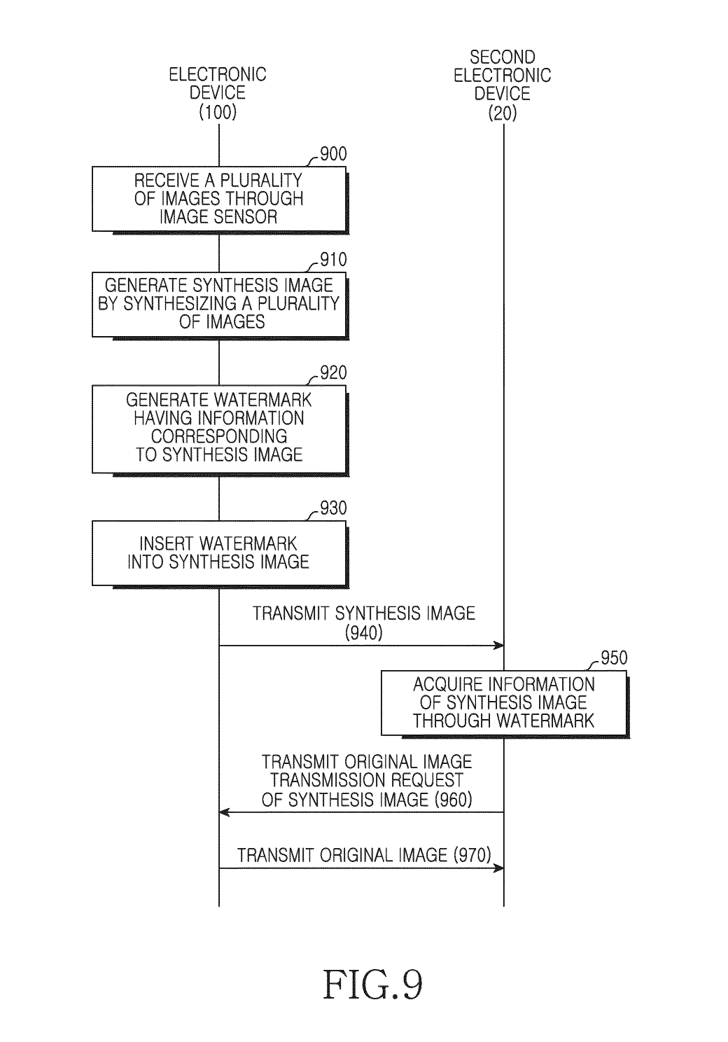

FIG. 9 is a flowchart illustrating a method of operating an electronic device and a second electronic device according to various embodiments of the present disclosure.

Referring to FIG. 9, at operation 900, the electronic device 100 may receive a plurality of images through an image sensor.

According to various embodiments of the present disclosure, the electronic device 100 may acquire a plurality of images using various functions such as Dual shot, Burst shot, Best shot, Eraser, High Dynamic Range (HDR), Drama of a subject, and/or the like.

Thereafter, at operation 910, the electronic device 100 may generate a synthesis image by synthesizing a plurality of images.

According to various embodiments of the present disclosure, the image editing unit 210 of the electronic device 100 may edit a portion of an image using a plurality of images or may generate a synthesis image through synthesis of various methods such as panorama image synthesis.

Thereafter, at operation 920, the electronic device 100 may generate a watermark having information corresponding to the synthesis image.

According to various embodiments of the present disclosure, the watermark generator 220 of the electronic device 100 may generate a watermark including a kind of a synthesis function of the synthesis image, a name of the original image, a synthesis date of the synthesis image, and/or the like.

According to various embodiments of the present disclosure, the watermark generator 220 may generate a watermark including user information having owner information of the synthesis image. For example, user information may include an owner name, terminal information, a phone number, ID or profile information of an SNS of the original file, and/or the like. Further, user information may include may include an original file transmission request to an owner of the original file from another electronic device. However, user information is not limited thereto and may include various information about an owner of the original file.

Thereafter, at operation 930, the electronic device 100 may insert a watermark into the synthesis image.

According to various embodiments of the present disclosure, the watermark insertion unit 230 of the electronic device 100 may insert a watermark provided from the watermark generator 220 into the synthesis image. For example, the watermark insertion unit 230 may insert a watermark into the synthesis image such that the watermark is not shown by a naked eye. For example, the watermark insertion unit 230 may insert the watermark into an edition file such that a user may not see the watermark when the file is viewed.

Thereafter, at operation 940, the electronic device 100 may transmit the synthesis image to the second electronic device 20.

According to various embodiments of the present disclosure, the file transmitting unit 240 of the electronic device 100 may transmit the synthesis image to the second electronic device 20 through a wireless connection method of at least one of WiFi, e-mail, SMS, NFC, SNS, and the like, and/or a wire connection method through a cable.

Thereafter, at operation 950, the second electronic device 20 may acquire information of the synthesis image through the watermark.

According to various embodiments of the present disclosure, the second electronic device 20 may extract a watermark of the synthesis image according to a predetermined rule and acquire synthesis image information included in the extracted watermark. The second electronic device 20 may determine whether the synthesis image is synthesized, a synthesis kind, and whether the original image exists.

Thereafter, at operation 960, the second electronic device 20 may transmit an original image transmission request of the synthesis image to the electronic device 100.

According to various embodiments of the present disclosure, the second electronic device 20 may input an original image transmission request instruction of the synthesis image to the electronic device 100 through the acquired synthesis image information.

Thereafter, at operation 970, the electronic device 100 may transmit the original image to the second electronic device 20.

According to various embodiments of the present disclosure, in response to receiving the original image transmission request, the electronic device 100 may transmit the original image of the synthesis image to the second electronic device 20 or may transmit the original image into which a watermark is inserted to the second electronic device 20 according to whether the electronic device 100 allows. For example, the original image may be an image used for the synthesis image and may be an image in which at least a portion of the original image is edited. A wireless connection method of at least one of WiFi, e-mail, SMS, NFC, SNS, and the like, and/or a wire connection method through a cable may be applied to such transmission. However, such a transmission method is not limited thereto.

An instruction set of such each operation may be stored in at least one module at the memory 110. In this case, a module stored at the memory 110 may be executed by at least one processor 122.

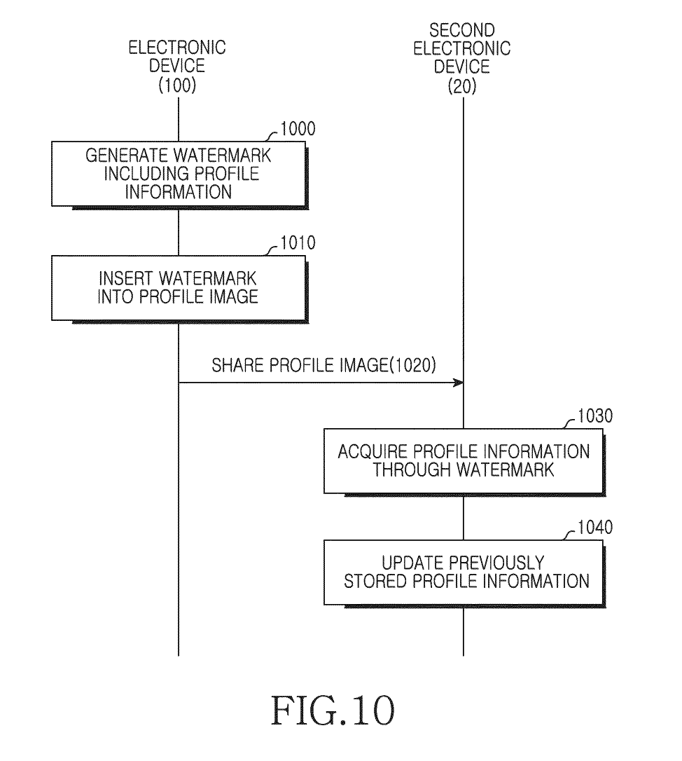

FIG. 10 is a flowchart illustrating a method of operating an electronic device and a second electronic device according to various embodiments of the present disclosure.

Referring to FIG. 10, at operation 1000, the electronic device 100 may generate a watermark including profile information.

According to various embodiments of the present disclosure, the electronic device 100 may generate a watermark including user profile information. As an example, the profile information may include a user name, a user phone number, a user SNS ID, a user picture, a user e-mail address, and/or the like.

Thereafter, at operation 1010, the electronic device 100 may insert a watermark into a profile image.

According to various embodiments of the present disclosure, the electronic device 100 may insert a watermark into a profile image exposed on an SNS.

Thereafter, at operation 1020, the electronic device 100 may share the profile image with the second electronic device 20.

Thereafter, at operation 1030, the second electronic device 20 may acquire profile information through the watermark.

According to various embodiments of the present disclosure, the second electronic device 20 may extract a watermark of the profile image according to a predetermined rule and acquire profile information included in the extracted watermark.

Thereafter, at operation 1040, the second electronic device 20 may update previously stored profile information.

According to various embodiments of the present disclosure, the second electronic device 20 may update previously stored information through extracted profile information. Further, if previously stored information does not exist, then the second electronic device 20 may input new profile information.

An instruction set of such each operation may be stored into at least one module at the memory 110. In this case, the module stored at the memory 110 may be executed by at least one processor 122.

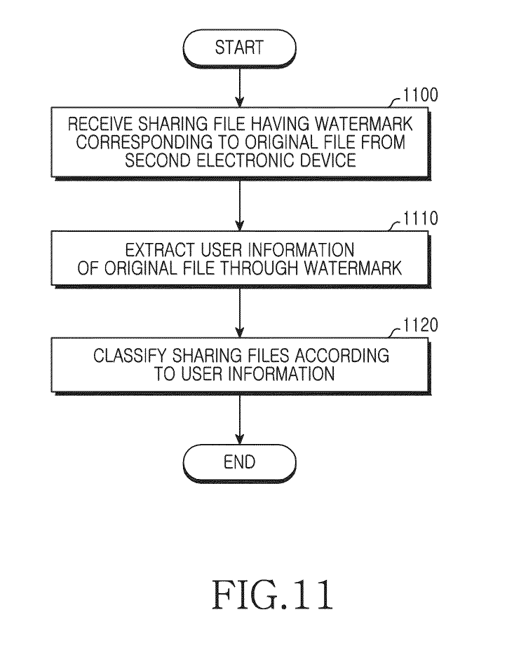

FIG. 11 is a flowchart illustrating a method of operating an electronic device according to various embodiments of the present disclosure.

Referring to FIG. 11, at operation 1100, an electronic device 100 may receive a sharing file having a watermark corresponding to an original file from the second electronic device.

Thereafter, at operation 1110, the electronic device 100 may extract user information of the original file through the watermark.

According to various embodiments of the present disclosure, a second electronic device 20 may extract a watermark of a sharing file according to a predetermined rule and acquire user information included in the extracted watermark.

Thereafter, at operation 1120, the electronic device 100 may classify sharing files according to user information.

According to various embodiments of the present disclosure, the electronic device 100 may manage the same sharing file as the extracted user information. If the sharing file is an image file, then the electronic device 100 may use a method of generating a folder of a name related to original owner information and storing the file at a folder and may write corresponding information in a tag file that manages a plurality of image files and generate a tagging area within an image that manages an individual image and write information of a watermark in a corresponding area. However, the present disclosure is not limited thereto, and sharing files may be classified with various methods.

An instruction set of such each operation may be stored in at least one module at the memory 110. In this case, the module stored at the memory 110 may be executed by at least one processor 122.

According to various embodiments of the present disclosure, each module may be formed with software, firmware, hardware, or a combination thereof. A partial module or an entire module may be formed in an entity and may equally perform a function of each module. According to various embodiments of the present disclosure, each operation may be executed sequentially, repeatedly, or in parallel. A partial operation may be omitted or other operations may be added and executed. For example, each operation may be executed by a corresponding module described in an embodiment of the present disclosure.

If various embodiments of the present disclosure are implemented with software, a non-transient computer readable storage medium that stores at least one program (software module) may be provided. At least one program stored at a non-transient computer readable storage medium may be executed by at least one processor 122 within the electronic device 100. At least one program may include an instruction that enables the electronic device 100 to execute methods according to various embodiments of the present disclosure.

Such a program (e.g., software module, software, and/or the like) may be stored at a non-volatile memory including a random access memory (RAM) and a flash memory, a read-only memory (ROM), an electrically erasable and programmable ROM (EEPROM), a magnetic disk storage device, a compact disk ROM (CD-ROM), a digital versatile disk (DVD), or an optical storage device of other form, and a magnetic cassette. Alternatively, the program may be stored at a memory formed with a combination of a portion or the entire thereof. Further, each constituent memory may be included in plural.

The program may be stored at an attachable storage device that may access to the electronic device 100 through a communication network such as Internet, Intranet, a local area network (LAN), a wireless LAN (WLAN), or a storage area network (SAN) or a communication network formed with a combination thereof. Such a storage device may access to the electronic device 100 through an external port device.

Further, a separate storage device on the communication network may access to the electronic device 100.

According to various embodiments, an electronic device can determine information about an original file and owner information of an original file from a received file and may provide a user interface that can intuitionally request transmission of a specific original file.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of operating an electronic device, the method comprising:
generating an edition file edited in a form that shares an original file;
generating a first sharing file by inserting a watermark into the edition file;
transmitting the first sharing file to an external electronic device;
receiving a transmission request of a second sharing file corresponding to the original file from the external electronic device; and
transmitting the second sharing file to the external electronic device.

2. The method of claim 1, wherein, if the original file is an image file, the watermark comprises at least one of sound data of the image file and information about the image file.

3. The method of claim 2, wherein the information of the image file comprises at least one of photographing time information and information about a photographed person in the image file.

4. The method of claim 1, wherein the watermark comprises at least one of a file name, Identification (ID), internal metadata, and external metadata of the original file.

5. The method of claim 4, wherein, if the original file is an image file, the internal metadata comprises at least one of a photographing time of the image file, a photographing location of the image file, sensor sensitivity of an image sensor that photographs the image file, and an exposure time of the image sensor.

6. The method of claim 4, wherein, if the original file is an image file, the external metadata comprises information about a subject.

7. The method of claim 1, wherein, if the original file is an image file, the edition file is formed by executing at least one of resizing, cropping, and filtering of the image file.

8. The method of claim 1, wherein, if the original file is a plurality of image files, the edition file is an edition file of a synthesis file of a plurality of image files.

9. The method of claim 8, wherein the watermark comprises at least one of a method of synthesizing the synthesis file and information of each of the plurality of image files.

10. The method of claim 1, wherein transmission of the first sharing file is performed with at least one of a wireless connection method of one of WiFi, e-mail, Short Message Service (SMS), Near Field Communication (NFC), and Social Networking Service (SNS), and a wire connection method through a cable.

11. The method of claim 1, wherein the second sharing file is the original file or is a file similar to a format of the original file rather than the first sharing file.

12. The method of claim 1, further comprising:
receiving the original file from the external electronic device.

13. An electronic device, comprising:
a watermark generation module;
a communication module;
a memory; and
at least one processor,
wherein the at least one processor controls to generate an edition file edited in a form that shares an original file, to generate a first sharing file by inserting a watermark into the edition file, to transmit the first sharing file to an external electronic device, and to transmit a second sharing file to the external electronic device in response to receiving a second sharing file transmission request corresponding to the original file from the external electronic device.

14. The electronic device of claim 13, wherein, if the original file is an image file, the watermark comprises at least one of sound data of the image file and information of the image file.

15. The electronic device of claim 14, wherein the information of the image file comprises at least one of photographing time information and information about a photographed person in the image file.

16. The electronic device of claim 13, wherein, if the original file is an image file, the processor generates the edition file by executing at least one of resizing, cropping, and filtering of the image file

17. The electronic device of claim 13, wherein, if the original file is a plurality of image files, the edition file is an edition file of a synthesis file of the plurality of image files.

18. The electronic device of claim 17, wherein the watermark comprises at least one of a method of synthesizing the synthesis file and information of each of the plurality of image files.

19. A method of operating an electronic device, the method comprising:
receiving a first sharing file from an external electronic device, wherein the first sharing file is a file generated by inserting a watermark into an edition file edited in a form that shares an original file in the external electronic device;
requesting to transmit a second sharing file corresponding to the original file to the external electronic device; and
receiving the second sharing file from the external electronic device.

20. The method of claim 19, further comprising:
determining user information of the original file using the watermark inserted into the edition file.
